(19) United States
(12) Patent Application Publication
(10) Pub. No.: US 2007/0135607 A1
(43) Pub. Date: Jun. 14, 2007

(54) TDI prepolymers with improved processing characteristics

(76) Inventor: James W. Rosthauser, Pittsburgh, PA (US)

Correspondence Address: BAYER MATERIAL SCIENCE LLC, 100 BAYER ROAD, PITTSBURGH, PA, 15205, US

(21) Appl. No.: 11/653,803

(22) Filed: Jan. 16, 2007

Related U.S. Application Data
(62) Division of application No. 10/870,126, filed on Jun. 17, 2004.

(51) Int. Cl. C08G 18/00; B05D 3/02

(52) U.S. Cl. 528/44; 427/384

(57) ABSTRACT

The present invention relates to novel prepolymers of toluene diisocyanate and to a process for the preparation of these toluene diisocyanate prepolymers. This invention also relates to a process for the production of a polyurethane backing or a frothed foam backing on a substrate, and to a process for forming a layer of blown, cellular urethane foam on a suitable substrate. These novel prepolymers comprise toluene diisocyanate prepolymers with a small quantity of an epoxide.

### BACKGROUND OF THE INVENTION

The present invention relates to prepolymers of toluene diisocyanate and to an improved process for the production of a polyurethane backing or a frothed foam on a substrate. The polyurethane backing or frothed foam comprises the reaction product of a polyisocyanate and an isocyanate-reactive component in the presence of a catalyst, and the polyisocyanate comprises a prepolymer of toluene diisocyanate which is modified with an epoxide.

Methods for improving stability and/or reactivity of polyisocyanates of the diphenylmethane series are also known and described in the art. See U.S. Pat. Nos. 3,793,362, 5,342,881, 5,726,240, 5,783,652 and 6,528,609. Most of these patents disclose blending or mixing an organic polyisocyanate with an epoxide or other compound. Toluene diisocyanate is not, however, mentioned by these patents.

U.S. Pat. Nos. 4,814,103, 6,127,463 and 6,166,128 disclose that the color of various organic polyisocyanates based on di- and polyisocyanates of the diphenylmethane series can be stabilized and/or reduced by the addition of epoxides alone or in combination with hindered phenols. These patents also do not disclose toluene diisocyanate as a suitable diisocyanate.

Toluene diisocyanate based prepolymers are desirable as these generally result in lower viscosities at a given NCO comparison to other diisocyanates. Some disadvantages commonly associated with the known prepolymers, and particularly those based on TDI, include the high vapor pressure of TDI and potential industrial hygiene issues associated with the vapor pressure and large quantities of monomeric TDI. Various methods to reduce the monomeric diisocyanate content of isocyanate prepolymers are known and described in, for example, U.S. Pat. Nos. 3,183,112, 3,248,372, 3,384,624, 3,883,577, 4,061,662, 4,296,159, and 4,683,279.

Prepolymers having low monomeric toluene diisocyanate contents are described in U.S. Pat. Nos. 5,817,734 and 5,925,781. These are liquid toluene diisocyanate/polyether/polymethylene poly(phenyl isocyanate) prepolymers having a viscosity of less than about 10,000 mPa·s at room temperature and containing about 1% or less of monomeric TDI.

Various processes for making polyurethane backed carpets and backed substrates are known and described in the art, including for example, U.S. Pat. Nos. 4,035,529, 4,132,817, 4,171,395, 4,296,159, 4,405,393 and 4,512,831. Suitable isocyanates include di- and polymethylene poly(phenyl isocyanates), toluene diisocyanates, other aromatic isocyanates, and prepolymers thereof. The process steps vary depending on whether carpet or another substrate is used.

Copending U.S. application Ser. No. ______ (Agent docket number P08224), filed in the U.S. Patent and Trademark Office or the same day as the present application, and which is commonly assigned, relates to an improved process for the preparation of carbodiimide modified organic isocyanate, preferably polyphenylmethane polyisocyanates, and most preferably diphenylmethane diisocyanates. This process comprises (1) neutralizing acidic impurities in an organic isocyanate, (2) partially carbodiimidizing isocyanate groups of the neutralized organic isocyanate, (3) terminating the carbodiimidization reaction.

Prepolymers of the present invention have improved processing characteristics including improved reactivity of the prepolymer with isocyanate-reactive components, elimination of voids or bubbles in froth foam applied layers and composite structures containing them, and faster curing characteristics such that productivity rates are increased. Additionally, the faster reaction rates may reduce the amount of TDI emissions evolved during the processing of the prepolymers,

### SUMMARY OF THE INVENTION

This invention relates to novel toluene diisocyanate prepolymers, and to a process for the preparation of these novel toluene diisocyanate prepolymers.

The toluene diisocyanate prepolymer compositions of the present invention comprise:
(A) from 99.99 to 95, preferably 99.9 to 97% by weight, based on 100% of the total weight of (A) and (B), of a prepolymer of toluene diisocyanate having an NCO group content of from about 2 to about 40, preferably 5 to 25% and which comprises the reaction product of:
   (1) toluene diisocyanate having from about 100 to about 60% by weight of the 2,4-isomer and from about 0 to about 40% by weight of the 2,6-isomer, and
   (2) an isocyanate-reactive component having a functionality of from about 1.5 to about 8, and an OH number of from about 14 to about 1,870, and preferably comprising a polyether polyol; and
(B) from 0.01% to 5.0% by weight, preferably 0.1 to 3.0% by weight, based on 100% of the total weight of (A) and (B), of one or more epoxide having an epoxide equivalent weight of from about 44 to about 400.

The novel toluene diisocyanate prepolymers of present invention additionally comprise an epoxide.

The process of preparing the novel toluene diisocyanate prepolymers comprises:
(A) reacting (1) toluene diisocyanate having from about 100 to about 60% by weight of the 2,4-isomer and from about 0 to about 40% by weight of the 2,6-isomer, with (2) an isocyanate-reactive component comprising an isocyanate-reactive component (preferably a polyether polyol) having a functionality of from about 1.5 to about 8, and an OH number of from about 14 to about 1870 to form a prepolymer having an NCO group content of from about 2 to about 40%; and
(B) adding (1) about 0.01 to about 5.0% by weight, based on 100% of the combined weight of the epoxide and the prepolymer, of an epoxide having an epoxide equivalent weight of from about 44 to about 400, to (2) about 99.99 to about 95% by weight of the prepolymer formed in (A).

In this process, it is preferred to add about 0.1 to about 3.0% by weight of epoxide to about 99.9 to about 97.0% by weight of the prepolymer formed in (A).

In accordance with the present invention, there are several different processes by which the novel prepolymers of this invention may be prepared. In addition to the process described above, the epoxide may be added to the toluene diisocyanate, and this blend reacted with an isocyanate-reactive component to form a prepolymer. Similarly, the epoxide may be added to the isocyanate-reactive component, and this blend reacted with toluene diisocyanate to form a prepolymer. It is also possible to add the epoxide to the reacting mixture of the toluene diisocyanate and the isocyanate-reactive component.

The present invention also relates to a frothed foam and to a process for preparing a frothed foam. These frothed foams comprise the reaction product of a polyurethane forming mixture which comprises:
(A) a relatively high molecular weight polyether polyol having an average of from 1.5 to about 8, preferably from 2 to about 3 hydroxyl groups per molecule and an average hydroxyl equivalent weight of from about 250 to about 2,200, preferably from about 600 to about 2,000 or a mixture of such polyols;
(B) a relatively low molecular weight polyol having an average of from about 2 to about 8, preferably from 2 to about 3 hydroxyl groups per molecule and an average equivalent weight of from about 31 to about 230 preferably from about 31 to about 200 or a mixture of such polyols;
(C) optionally, water;
(D) one or more catalysts or catalyst solution(s)
(E) the novel TDI prepolymers of this invention as described hereinabove; and
(F) an inorganic filler component;
   wherein:
   (1) components (A) and (B) are present in quantities such that the ratio of the number of hydroxyl equivalents contributed by component (B) to the number of hydroxyl equivalents contributed by component (A) is from about 0.8:1 to about 5.5:1, preferably from about 0.8:1 to about 4:1;
   (2) components (A), (B), (C) and (E) are present in quantities so as to provide an NCO to OH (isocyanate reactive components) ratio of from about 0.90:1 to about 1.5:1, preferably from about 1:1 to about 1.25:1;
   (3) when component (C) is present, it is present in an amount from about 0.01 to about 5 parts per 100 parts of the isocyanate reactive mixture of components (A), (B), (C) and (D) so as to provide a water blown, frothed foam;
   (4) component (D) is present in an amount necessary to promote the reaction of the isocyanate and isocyanate reactive components within the time the frothed foam or laminate resides in an oven and at the temperature inside the oven; and
   (5) component (F) is present in quantities of from about 0 parts to about 300 parts, preferably from about 0 parts to about 200 parts, per 100 parts by weight of liquid reactants (i.e. components (A), (B), (C), (D) and (E)).

Another aspect of the present invention is directed to a process for the production of a polyurethane backing or a frothed foam backing on a substrate. Preferred substrates include the underneath side of an unfinished carpet. This process comprises the steps of:
(I) mixing these novel toluene diisocyanate prepolymers with an isocyanate-reactive blend in the presence of a catalyst to form a reaction mixture;
(II) mechanically frothing the reaction mixture while introducing an inert gas;
(III) applying the frothed reaction mixture to a substrate; and
(IV) curing the frothed reaction mixture to form a polyurethane backing or a frothed foam on the substrate.

In an alternate embodiment of the present invention, the process is directed to forming a layer of blown, cellular, urethane foam on the back of a suitable substrate. This process comprises:
(I) preparing a mixture of reactive foam forming agents containing a sufficient quantity of water to cause chemical blowing of the mixture when heated sufficiently and controlling the temperature of the reactive mixture to a temperature of between about 60 and 100° F.;
(II) mechanically frothing the reactive mixture while introducing an inert gas;
(III) depositing the mixture of reactive foam forming agents onto a substrate which is at a controlled temperature;
(IV) optionally, spreading the deposited mixture of reactive foam forming agents over the substrate into a relatively uniform layer;
(V) optionally, heating the reactive foam forming mixture to assist or improve chemical blowing; and
(VI) allowing the reactive foam forming mixture on the substrate to cure.

Obviously, in this embodiment, the mixture of reactive foam forming agents comprises the novel toluene diisocyanate prepolymer of the present invention and at least one isocyanate-reactive component, in addition to the water.

In the above described embodiment of the present invention, the temperature of the mixture of reactive foam foaming agents typically gets hot upon mixing. Thus, to control the temperature of the reaction, one typically, cools or chills the mixture.

In the embodiments of forming a polyurethane backing, a frothed foam backing or a blown, cellular urethane foam on a substrate, the substrate is typically fed on a conveyor (which is preferably endless) along a conveyor path from a forward end to a rearward end. A froth-generator mixer dispenses the reactive mixture onto the substrate. Preferably this reactive mixture is spread into a generally uniform layer on the upper surface. Spreading of the reactive mixture can be by passing the upper surface of the reactive mixture under, for example, a doctor bar, roller or any stationary rod to generate the generally uniform layer on the surface. Alternately, an air knife can be used to spread the reactive mixture into a uniform layer. Optionally, a second conveyor belt, parallel to the first conveyor belt or a roller, feeds a second liner sheet or substrate along the conveyor path so that the second liner sheet is positioned over the layers of foam laminate. As the layers of foam laminate pass along the conveyor path, the reactive mixture of foam forming material is sandwiched between the first and second liners or substrates, and is compressed between the conveyor belts to a selected thickness by means of, for example, a marriage roller. This laminated foam then passes through an oven where it is heated to cure the layer of foam and form the resultant composite structure.

### DETAILED DESCRIPTION OF THE INVENTION

Suitable isocyanates for making the prepolymers of the present invention comprise toluene diisocyanates. The toluene diisocyanate starting material typically has an NCO group content from greater than about 48.0% to less than about 48.5%, and preferably about 48.1 to about 48.3%. Toluene diisocyanates used in the present invention typically has an NCO group content of greater than about 48.0%, and preferably at least about 48.1%. The toluene diisocyanate suitable herein also typically has an NCO group content of less than about 48.5%, and preferably of less than or equal to about 48.3%. The suitable toluene diisocyanates for the present invention may have an NCO group content ranging between any combination of these upper and lower values, inclusive, e.g., from greater than about 48.0% to less than about 48.5%, and preferably from about 48.1% to about 48.3%.

Suitable toluene diisocyanates of the present invention typically comprise 2,4-toluene diisocyanate, 2,6-toluene diisocyanate and mixtures of these two isomers. The toluene di isocyanate typically has at least about 60% up to 100% by weight of the 2,4-isomer of toluene diisocyanate, and from 0 up to 40% by weight of the 2,6-isomer of toluene diisocyanate. The %'s by weight of the 2,4-isomer and the 2,6-isomer totals 100% by weight of the toluene diisocyanate. In one embodiment, the toluene diisocyanate comprises from about 79.5% to about 81.5% by weight of the 2,4-isomer and from about 18.5 to about 20.5% by weight of the 2,6-isomer. In still another embodiment, toluene diisocyanate comprises from about 65 to about 67% by weight of the 2,4-isomer and from about 33 to about 35% by weight of the 2,6-isomer. In a final embodiment, the toluene diisocyanate comprises virtually all 2,4-isomer. More specifically, in this embodiment, there is from about 98.0% to about 100% by weight of 2,4-toluene diisocyanate and from about 0% to about 2% by weight of 2,6-toluene diisocyanate.

The %'s by weight of the 2,4-isomer and the 2,6-isomer of toluene diisocyanate totals 100% by weight of the toluene diisocyanate.

Suitable compounds to be used as isocyanate-reactive compounds which react with the toluene diisocyanate to form the prepolymer include, for example, compounds which typically contain at least about 1.5 isocyanate-reactive groups, more preferably at least about 2 and most preferably at least about 2 isocyanate-reactive groups. These compounds also typically contain less than or equal to about 8 isocyanate-reactive groups, more preferably less than or equal to about 4 and most preferably less than or equal to about 3 isocyanate-reactive groups. It is also possible that these compounds have any number of isocyanate-reactive groups ranging between any combination of these upper and lower values, inclusive, e.g., from about 1.5 to about 8, more preferably from 2 to 4 and most preferably from about 2 to about 3.

Suitable compounds to be used in forming the prepolymer of toluene diisocyanate in accordance with the present invention typically have a molecular weight of at least about 60, more preferably at least about 500 and most preferably at least about 1,000. These compounds also typically have a molecular weight of less than or equal to about 8,000, more preferably less than or equal to about 7,000 and most preferably less than or equal to about 6,000. It is also possible that these compounds have any molecular weight ranging between any combination of these upper and lower values, inclusive, e.g., from about 60 to about 8,000, more preferably from about 500 to about 7,000 and most preferably from about 1,000 to about 6,000.

Suitable compounds to be used as in forming the prepolymer in accordance with the present invention typically have an OH number of at least about 14, more preferably at least about 20 and most preferably at least about 26. These compounds also typically have an OH number of less than or equal to about 1870, more preferably less than or equal to about 600 and most preferably less than or equal to about 300. It is also possible that these compounds have any OH number ranging between any combination of these upper and lower values, inclusive, e.g., from about 14 to about 1870, more preferably from about 20 to about 600 and most preferably from about 28 to about 112.

Examples of suitable compounds to be reacted with TDI to form the prepolymers required by the present invention include compounds such as, for example, polyether polyols, polyester polyols, polycarbonate diols, polyhydric polythioethers, polyacetals, aliphatic thiols, solids containing polyols including those selected from the group consisting of graft polyols, polyisocyanate polyaddition polyols, polymer polyols, PHD polyols and mixtures thereof, etc. Lower molecular weight polyols which are sometimes referred to as chain extenders and/or cross linkers are also suitable, provided they are within the ranges set forth above for functionality, molecular weight and OH number, and satisfy the requirements for types of isocyanate-reactive groups. It is preferred to use a polyether polyol.

Hydroxyl-containing polyethers are suitable for use as the isocyanate-reactive component in forming the TDI prepolymers. Suitable hydroxyl-containing polyethers can be prepared, for example, by the polymerization of epoxides such as ethylene oxide, propylene oxide, butylene oxide, tetrahydrofuran, styrene oxide, or epichlorohydrin, optionally in the presence of BF₃, or by chemical addition of such epoxides, optionally as mixtures or successively, to starting components containing reactive hydrogen atoms, such as water, alcohols, or amines. Examples of such starting components include ethylene glycol, 1,2- or 1,3-propanediol, 1,2-, 1,3-, or 1,4-butanediol, glycerin, trimethylolpropane, pentaerythritol, 4,4′-dihydroxydiphenyl-propane, aniline, 2,4- or 2,6-diaminotoluene, ammonia, ethanolamine, triethanolamine, or ethylene diamine. Sucrose polyethers of the type described, for example, in German Auslegeschriften 1,176,358 and 1,064,938 may also be used according to the invention. Polyethers that contain predominantly primary hydroxyl groups (up to about 90% by weight, based on all of the hydroxyl groups in the polyether) are particularly preferred. Polyethers modified by vinyl polymers of the kind obtained, for example, by the polymerization of styrene and acrylonitrile in the presence of polyethers (e.g., U.S. Pat. Nos. 3,383,351, 3,304,273, 3,523,093, and 3,110,695, the disclosures of which are hereby incorporated by reference, and German Patentschrift 1,152,536) are also suitable, as are polybutadienes containing hydroxyl groups. Particularly preferred polyethers include polyoxyalkylene polyether polyols, such as polyoxyethylene diol and triol, polyoxypropylene diol and triol, and polyoxypropylene diols and triols that have been capped with polyoxyethylene blocks.

Hydroxyl-containing polyesters are also suitable for use as the isocyanate-reactive component. Suitable hydroxyl-containing polyesters include reaction products of polyhydric alcohols (preferably diols), optionally with the addition of trihydric alcohols, and polybasic (preferably dibasic) carboxylic acids. Instead of free polycarboxylic acids, the corresponding polycarboxylic acid anhydrides or corresponding polycarboxylic acid esters of lower alcohols or mixtures thereof may be used for preparing the polyesters. The polycarboxylic acids may be aliphatic, cycloaliphatic, aromatic, or heterocyclic and may be substituted, e.g., by halogen atoms, and/or unsaturated. Suitable polycarboxylic acids include succinic acid, adipic acid, suberic acid, azelaic acid, sebacic acid, phthalic acid, isophthalic acid, trimellitic acid, phthalic acid anhydride, tetrahydrophthalic acid anhydride, hexahydrophthalic acid anhydride, tetrachlorophthalic acid anhydride, endo-methylene tetrahydrophthalic acid anhydride, glutaric acid anhydride, maleic acid, maleic acid anhydride, fumaric acid, dimeric and trimeric fatty acids, dimethyl terephthalic, and terephthalic acid bis-glycol esters. Suitable polyhydric alcohols include ethylene glycol, 1,2- and 1,3-propanediol, 1,4- and 2,3-butanediol, 1,6-hexanediol, 1,8-octanediol, neopentyl glycol, 1,3- and 1,4-bis(hydroxymethyl) cyclohexane, 2-methyl-1,3-propanediol, glycerol, trimethylolpropane, 1,2,6-hexanetriol, 1,2,4-butanetriol, trimethylolethane, pentaerythritol, quinitol, mannitol, sorbitol, methyl glycoside, diethylene glycol, triethylene glycol, tetraethylene glycol, polyethylene glycols, dipropylene glycol, polypropylene glycols, dibutylene glycol, and polybutylene glycols. The polyesters may also contain a proportion of carboxyl end groups. Polyesters of lactones, such as ε-caprolactone, or of hydroxycarboxylic acids, such as ω-hydroxycaproic acid, may also be used. Hydrolytically stable polyesters are preferably used in order to obtain the greatest benefit relative to the hydrolytic stability of the final product. Preferred polyesters include polyesters obtained from adipic acid or isophthalic acid and straight chained or branched diols, as well as lactone polyesters, preferably those based on caprolactone and diols.

Suitable polyacetals include compounds obtained from the condensation of glycols, such as diethylene glycol, triethylene glycol, 4,4′-dihydroxydiphenylmethane, and hexanediol, with formaldehyde or by the polymerization of cyclic acetals, such as trioxane.

Suitable polycarbonates include those prepared by the reaction of diols, such as 1,3-propanediol, 1,4-butanediol, 1,6-hexanediol, diethylene glycol, triethylene glycol, tetraethylene glycol, or thiodiglycol, with phosgene or diaryl carbonates such as diphenyl carbonate (German Auslegeschriften 1,694,080, 1,915,908, and 2,221,751; German Offenlegungsschrift 2,605,024).

Suitable polyester carbonates include those prepared by the reaction of polyester diols, with or without other diols such as 1,3-propanediol, 1,4-butanediol, 1,6-hexanediol, diethylene glycol, triethylene glycol, tetraethylene glycol, or thiodiglycol, with phosgene, cyclic carbonates, or diaryl carbonates such as diphenyl carbonate. Suitable polyester carbonates more generally include compounds such as those disclosed in U.S. Pat. No. 4,430,484, the disclosure of which is hereby incorporated by reference.

Suitable polythioethers include the condensation products obtained by the reaction of thiodiglycol, either alone, or with other glycols, formaldehyde, or amino alcohols. The products obtained are polythio-mixed ethers, polythioether esters, or polythioether ester amides, depending on the components used.

Although less preferred, other suitable hydroxyl-containing compounds include polyhydroxyl compounds already containing urethane or urea groups and modified or unmodified natural polyols. Products of addition of alkylene oxides to phenol-formaldehyde resins or to urea-formaldehyde resins are also suitable. Furthermore, amide groups may be introduced into the polyhydroxyl compounds as described, for example, in German Offenlegungsschrift 2,559,372.

General discussions of representative hydroxyl-containing compounds that may be used according to the present invention can be found, for example, in Polyurethanes, Chemistry and Technology by Saunders and Frisch, Interscience Publishers, New York, London, Volume 1,1962, pages 32-42 and pages 44-54, and Volume II, 1964, pages 5-6 and 198-199, and in Kunststoff-Handbuch, Volume VII, Vieweg-Hochtlen, Carl-Hanser-Verlag, Munich, 1966, on pages 45 to 71.

Other suitable hydroxyl-containing materials include those compounds which have low molecular weights, i.e. from about 60 to less than about 399. Among the suitable compounds are, 2-methyl-1,3-propanediol, ethylene glycol, 1,2- and 1,3-propanediol, 1,3- and 1,4- and 2,3-butanediol, 1,6-hexanediol, 1,10-decanediol, diethylene glycol, triethylene glycol, tetraethylene glycol, dipropylene glycol, tripropylene glycol, glycerol, trimethylolpropane, neopentyl glycol, cyclohexane-dimethanol, 2,2,4-trimethylpentane-1,3-diol, sorbitol, sucrose, etc. Preferred are low molecular weight ethers such as, for example, diethylene glycol and dipropylene glycol.

Also suitable are low molecular weight hydroxyl-containing polyethers. These can be prepared, for example, by the methods discussed above for the higher molecular weight hydroxy-containing polyethers except that only lower molecular weight materials are used.

Particularly preferred isocyanate-reactive compounds for the present invention include polyoxyalkylene polyether polyols, such as polyoxyethylene diol, polyoxypropylene diol, polyoxybutylene diol, and polytetramethylene diol having the requisite molecular weights as described hereinabove.

Any chemical compound which contains the epoxide (oxirane) functionality is suitable in the preparation of the mixtures of the present invention. The term “epoxide” or “epoxy” as used herein refers to any organic compound or resin comprising at least one group comprising a three membered oxirane ring. Preferably two or more oxirane groups are present in the epoxide compound or resin in order to obtain the polyisocyanate compositions with consistent reactivity profiles of the instant invention. The epoxide equivalent weight (EEW) range of suitable epoxides is from about 44 to 400, preferably 100 to 350 and most preferably 150 to 300. Both aromatic and aliphatic polyepoxides may be used, and are well known.

It is somewhat less preferred that the epoxy comprises an aromatic polyepoxide due to the tendency of them to cause yellowing as well as their reduced efficacy. Examples of such aromatic polyepoxides include but are not limited to those selected from the group consisting of the polyglycidyl ethers of polyhydric phenols; glycidyl esters of aromatic carboxylic acids; N-glycidylaminoaromatics such as N-glycidylaminobenzene, N,N,N′,N′-tetraglycidyl-4,4′-bis-aminophenyl methane, and diglycidylaminobenzene; glycidylamino-glycidyloxyaromatics such as glycidyl-aminoglycidyloxybenzene; and mixtures thereof.

The aromatic polyepoxide resins, comprised of the polyglycidyl-ethers of polyhydric phenols including bis(phenol A), are also less preferred because they contain hydroxyl groups and thus, react with the polyisocyanate mixtures. Thus, this reduces the isocyanate content. Also, less preferred are aliphatic epoxides containing hydroxyl groups, e.g., glycidol, for the same reason. The preferred epoxides for use according to the invention are the aliphatic epoxides which do not contain hydroxyl groups.

Suitable for use are C₂-C₁₈ aliphatic epoxides such as, for example, ethylene oxide, propylene oxide, 1,2-butene oxide, 2,3-butene oxide (cis and/or trans), isobutylene oxide, 1,2-pentene oxide, 2,3-pentene oxide, cyclopentene oxide, 1,2-hexene oxide, cyclohexene oxide, and the like and mixtures thereof.

Examples of useful aliphatic polyepoxides include but are not limited to those selected from the group consisting of vinyl cyclohexene dioxide; butadiene dioxide; triglycidyl isocyanurate; and those containing ether linkages such as triglycidyl pentaerythritol, tetraglycidyl pentaery-thritol, diglycidylethers of cylcohexane dimethanol and the diglycidylethers of other diols known to those skilled in the art, 1,4-bis(2,3-epoxypropoxy)benzene; 1,3-bis(2,3-epoxypropoxy)benzene; 4,4′-bis(2,3-epoxypropoxy)diphenyl ether; 1,8-bis(2,3-epoxypropoxy)octane; 1,4-bis(2,3-epoxypropoxy)cyclohexane; 4,4′-(2-hydroxy-3,4-epoxybutoxy)-diphenyl dimethyl methane; 1,3-bis(4,5-epoxypentoxy)-5-chlorobenzene; 1,4-bis(3,4-epoxybutoxy)-2-chlorocyclohexane; diglycidyl thioether; diglycidyl ether; 1,2,5,6-diepoxyhexane-3; 1,2,5,6-diepoxyhexane; those containing ester groups such as ERL 4221, a product of Dow Corporation, illustrated in U.S. Pat. No. 4,814,103, the disclosure of which is hereby incorporated by reference, and mixtures thereof.

Other useful epoxides are listed in, for example, U.S. Pat. No. 3,298,998, the disclosure of which is hereby incorporated by reference. These compounds include but are not limited to those selected from the group consisting of bis[p-(2,3-epoxypropoxy)phenyl]cyclohexane; 2,2-bis[p-(2,3-epoxypropoxy)phenyl]norcamphane; 5,5-bis[(2,3-epoxypropoxy)phenyl]hexahydro-4,6-methanoindane; 2,2-bis[4-(2,3-epoxypropoxy)-3-methylphenyl]hexahydro-4,7-methanoindane; and 2-bis[p-2,3-epoxypropoxy)phenyl]-methylene-3-methylnorcamphane; and mixtures thereof. Other usable epoxides are found in, for example, Handbook of Epoxy Resin, Lee and Neville, McGraw-Hill, New York (1967) and U.S. Pat. No. 3,018,262, both of which are herein incorporated by reference.

Also, suitable epoxides for use in the present invention include the epoxidized dimer and trimer fatty acids, which are formed by epoxidizing the products of the polymerization of C₁₈ unsaturated fatty acids such as oleic acid, linoleic acid, linolenic acid, elaidic acid and the like. The use of a dimer or trimer fatty acid entity furnishes a higher molecular weight epoxide that is less likely to volatilize from the finished articles that the polyisocyanate compositions of the present invention are used to produce. The dimer fatty acid may have an acyclic, monocyclic, or bicyclic structure or comprise a mixture of compounds having different such structures.

Epoxidized mono-, di- and triglycerides prepared by epoxidation of the known unsaturated or partially unsaturated glycerides are preferred. The epoxidized glycerides may be prepared from any of the known fatty acid triglycerides available from natural or synthetic sources. The fatty acid group, which is connected to glycerol by an ester bond is usually a C₆-C₂₄ monocarboxylic acid (linear or branched; saturated, monounsaturated, or polyunsaturated). Such fatty acids and their equivalents are readily available at low cost from natural sources such as edible triglycerides. Specific illustrative fatty acids suitable for use include, but are not limited to, eicosanoic (arachidic) acid, heneicosanoic acid, docosanoic (behenic) acid, elaidic acid, tricosanoic acid, tetracosanoic (lignoceric) acid, caprylic acid, pelargonic acid, capric acid, caproic acid, lauric acid, palmitic acid, stearic acid, oleic acid, cetoleic acid, myristic acid, palmitoleic acid, gadoleic acid, erucic acid, rincinoleic acid, linoleic acid, linolenic acid, myristoleic acid, eleostearic acid, arachidonic acid, or mixtures or hydrogenated derivatives of these acids. The fatty acids may be derived synthetically or from natural sources such as triglyceride lipids. Mixtures of fatty acid entities, such as the mixtures of fatty acids typically obtained by hydrolysis (splitting) of a triglyceride are also suitable. These fatty acid triglycerides include, but are not limited to, fats and oils such as tallow, soybean oil, cottonseed oil, coconut oil, palm kernel oil, corn oil, fish oil, lard, butterfat, olive oil, palm oil, peanut oil, safflower seed oil, cocoa butter, sesame seed oil, rapeseed oil, sunflower seed oil, as well as fully or partially hydrogenated derivatives and mixtures of these triglycerides. Epoxidized linseed oil and epoxidized soybean oil are particularly preferred.

The mixtures of the present invention are prepared by mixing a) 95% to 99.99%, preferably 97% to 99.9%, more preferably 98% to 99.8% by weight, based on the combined weight of components (A) and (B), of a prepolymer of toluene diisocyanate as described above; with b) 0.01% to 5%, preferably 0.1% to 3%, more preferably 0.2% to 2% by weight, based on the combined weight of components (A) and (B), of one or more epoxides having an epoxide equivalent weight of 44 to 400.

The toluene diisocyanate prepolymers of the present invention are suitable for the preparation of polyurethane foams and of frothed polyurethane foams. In these embodiments, the prepolymers may be reacted or mixed with an isocyanate-reactive component, optionally in the presence of catalysts, blowing agents, etc. to form a reactive mixture which reacts to form a polyurethane foam. In frothed foams, this reactive mixture is frothed while adding air or an inert gas into the mixture before allowing the mixture to fully react.

In the process of preparing polyurethane-backed substrates or frothed foams according to the invention, the individual components of the polyurethane-forming composition or frothed foam composition are mixed and applied as a layer of preferably uniform thickness onto one surface of the substrate, and then cured. The novel toluene diisocyanate prepolymers which contain epoxide as described above are used as part, or all of the isocyanate component in these polyurethane-forming and/or frothed foam compositions.

A polyurethane forming froth is obtained by mechanically introducing an inert gas into the foam-forming composition. This is readily accomplished, for example, by a mixer such as, for example, a hand kitchen mixer fitted with a blade designed to mechanically whip or blend air and/or the inert gas into the mixture of urethane-forming components. Suitable blades include, for example, blades such as those which are employed in preparing whipped cream or for preparing meringue from egg whites or the like. Another method, which is more readily adaptable to large scale production, is by feeding a stream composed of a mixture of the urethane-forming components or separate streams of the urethane-forming components and a stream of air and/or inert gas into suitable froth generator-mixers. Suitable froth generator-mixers include, for example, those such as a cowls mixer (e.g. Oakes foamer) or pin mixer (e.g. Firestone mixer), where the frothed composition which emerges from the froth generator-mixer is directed onto the substrate upon which the froth composition thermosets into a flexible polyurethane foam.

Suitable inert gaseous substances which are employed in the present invention include any gaseous element, compound, or mixture thereof which exists in the gaseous state under standard conditions of temperature and pressure, i.e. 25° C. and 1 atmosphere. Some examples of suitable substances include, for example, xenon, helium, carbon dioxide, nitrogen, oxygen, propane, methane, ethane or mixtures thereof such as, for example, dried air and the like, provided such does not react with any of the urethane forming components.

In the process of forming laminates, a (preferably endless) conveyor belt feeds the substrate along a conveyor path from a forward end to a rearward end. A froth-generator mixer dispenses uncured reactive mixture onto the substrate, and this uncured reactive mixture is preferably spread out over the substrate to form a relatively uniform layer on the surface. Spreading or distributing this uncured reactive mixture over the substrate is typically by passing it under a doctor bar, blade, roller or any stationary rod to generate a generally uniform layer on the surface. Alternately, an air knife can be used to spread the urethane forming mixture into a uniform layer. The reactive mixture on the substrate is cured by passing through an oven.

In a further variation of the above embodiment, a roller or second conveyor belt, which is parallel to the first conveyor belt, feeds a second liner sheet along the conveyor path so that the second liner sheet is positioned over the layers of foam laminate. As the layers of foam laminate pass along the conveyor path, the foam material is sandwiched between the first and second liners and is compressed between the conveyor belts to a selected thickness by means of, for example, a marriage roller, a doctor blade or doctor bar, etc. This laminated foam then preferably passes through an oven where it is heated to cure the layer of foam and form the laminate.

The reactive foam mixtures or frothed foams used in these laminates comprise a mixture of an isocyanate component, an isocyanate-reactive component and optionally other components including, for example, water, catalysts, inorganic fillers, etc. The isocyanate component comprises the prepolymers of toluene diisocyanates which additionally contain epoxide as described above.

It is often preferred to pre-mix all components except the isocyanate prepolymer which contains the epoxide (and blowing agent when the system is frothed) to form a formulated “B-side”. When water is used as a blowing agent, it is pre-mixed with the polyol component to form a formulated “B-side”. When water is the blowing agent, it is typically present in amounts such that there is from 0.01 to 5%, preferably from 0.2 to 3%, and more preferably from 0.5 to 2% by weight of water, based on the total weight of the isocyanate-reactive component. This simplifies the metering and mixing of components at the time the polyurethane-forming composition is prepared. In preparing a frothed polyurethane backing, it is preferred to mix all components and then blend a gas into the mixture, using equipment such as an Oakes mixer or Firestone foamer.

The compositions described hereinabove have been found to be particularly effective in producing polyurethane backing and/or frothed foams for laminated composites. More specifically, these polyurethane backings and frothed foams preferably comprise the reaction product of a polyurethane forming mixture which comprises:
(A) a relatively high molecular weight isocyanate-reactive compound, preferably a polyether polyol having an average of from 1.5 to about 8, preferably from 2 to about 3 hydroxyl groups per molecule and an average hydroxyl equivalent weight of from about 500 to about 2,200, preferably from about 600 to about 2,000 or a mixture of such polyols;
(B) a relatively low molecular weight isocyanate-reactive compound, preferably a polyol, having an average of from about 2 to about 8, preferably from 2 to about 3 hydroxyl groups per molecule and an average equivalent weight of from about 31 to about 230 preferably from about 31 to about 200 or a mixture of such polyols;
(C) optionally, water;
(D) one or more catalysts or catalyst solutions;
(E) the novel TDI prepolymers which contain epoxide and as described hereinabove; and
(F) an inorganic filler component.

Other suitable froth foam formulations include those described in, for example, U.S. Pat. No. 3,821,130, the disclosure of which is hereby incorporated by reference. It is evident that in such formulations, the prepolymers of toluene diisocyanate which contain an epoxide component as described hereinabove are used as the isocyanate component. Possible applications for these froth foam formulations include, for example, sound dampening foams, etc.

Laminates of the present invention comprise a first substrate, a layer of polyurethane reactive mixture, and a second layer or substrate. Suitable substrates to be used as the first substrate include materials such as, for example, fiberglass, polystyrene, treated or non-treated release papers, other porous sound absorbing material as described in U.S. Pat. No. 6,698,543, the disclosure of which is hereby incorporated by reference; acoustic barriers as described in U.S. Pat. Nos. 3,489,242 and 3,909,488, the disclosures of which are hereby incorporated by reference; etc. Also suitable are barium sulfate filled polyurethane elastomers. The foam layer of these laminates comprises the reaction product of the toluene diisocyanate prepolymers which contain epoxide, and an isocyanate-reactive component, in the presence of one or more catalysts, water, and/or, optionally, inorganic fillers. The second layer or substrate in these laminates may be a component such as cloth, non-woven polyester, aluminum foil, etc., as described in U.S. Pat. No. 4,056,161, the disclosure of which is hereby incorporated by reference.

Other suitable substrates for the second layer of the laminates include, for example, polyethylene terephthalate (PET) films, aluminized PET films, jute, synthetic jute, non-woven fibers, especially non-woven polypropylene fiber, treated or non-treated release papers. These substrates can be coated with the polyurethane backing in order to produce roofing membranes or polyurethane carpet padding, which is installed prior to cushion backed or non-backed carpet. In addition, a substrate such as one mentioned above can be coated with an air frothed foam according to the invention, and the coated side of the substrate can then be protected from prematurely attaching to surfaces or to itself by covering it with coated release paper as is known in the art. These substrates are then attached to the surfaces by placing the coated side of the substrate in the desired position on the surface and then exerting pressure on the uncoated side of the substrate.

In general, after the polyurethane reaction mixture is applied to the first substrate, the thickness of the urethane mixture is adjusted by means of a roller, doctor blade or bar, air knife, stationary bar or rod, etc. Preferably, the urethane mixture is spread to a relatively uniform thickness before applying the second substrate or layer.

In cases where the second substrate or layer is a solid layer such as, for example, a polyethylene terephthalate film or similar material, it is preferred that the thickness of adjusted by use of a marriage roller placed directly after the second layer is placed onto the urethane mixture.

Suitable isocyanate-reactive components to be reacted with the TDI prepolymers which contain epoxide in the above processes for the production of a polyurethane backing or frothed foam backing on a substrate include compounds as described in U.S. Pat. No. 4,296,159, the disclosure of which is hereby incorporated by reference. In addition, these may additionally comprise surfactants, wetting agents, fillers, etc.,

In accordance with the present process for forming a layer of urethane foam on a suitable substrate, the substrates as described herein above are also suitable here. The mixture of reactive urethane foam forming agents is typically heated and controlled to a specified temperature as described in U.S. Pat. No. 4,296,159, the disclosure of which is hereby incorporated by reference. The reactive mixture of urethane foam is spread across the substrate by means of, for example, rollers, doctor blades or doctor bars, air knives, etc., to create a relatively uniform surface on the top of the urethane reactive foam. Finally, the reactive foam mixture is cured, thus forming the laminate.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all parts and percentages are parts by weight and percentages by weight, respectively.

### EXAMPLES

The following components were used in the working examples of the present application:

Isocyanate A: toluene diisocyanate having an NCO group content of about 48.3% and comprising 80% of the 2,4-isomer, and 20% of the 2,6-isomer.
Polyol A: a polyether polyol having a molecular weight of about 4,800 and prepared by adding a mixture of about 85% propylene oxide and 15% by weight ethylene oxide to glycerine such that about 75% of the hydroxyl groups are primary.
Epoxide A: polyepoxide based upon linseed oil and having an epoxide equivalent weight of about 180; commercially available as Epoxol 9-5 from Unitech Chemical Inc.

The following experiments were complete. Examples 1 and 3 are representative of the invention. Examples 2, 4 and 6 are comparative examples.

### Example 1

Isocyanate A (340 parts) was heated to 50° C. and Polyol A (657 parts) was added slowly while stirring such that the temperature of the mixture did not exceed 65° C. To the mixture was added Epoxide A (3 parts) and the mixture was stirred and heating maintained at 65° C. for 3 hours. The isocyanate content of the material was found to be 14.4% and the viscosity of the prepolymer was 640 mPa·s at 25° C.

### Example 2

Example 1 was repeated using 340 parts of Isocyanate A and 660 parts of Polyol A with no Epoxide. The reaction took 4 hours and the resulting prepolymer had 14.5% NCO and a viscosity of 650 mPa·s at 25° C.

### Example 3 and Example 4

The prepolymers of Example 1 and 2 were separately combined with a proprietary blend comprising one or more polyols, one or more catalysts, one or more surfactants, and water in an Oakes foamer in which air was injected to prepare the frothed foams used in Examples 3 and 4, respectively. In Examples 3 and 4, a composite was formed from each of the resulting frothed foams. The foams were (separately) deposited continuously onto a sound absorbing layer of barium sulfate filled polyurethane elastomer that was moving on an endless conveyer belt. Directly after each of the foams were deposited, a layer of aluminum foil was placed onto the uncured mass and pressed into it by use of a marriage roller. The marriage roller also determined the thickness of the composite layer formed. Each of the fresh composites were then transported through an oven set at 250° F. that was 120 feet long, at a speed of 50 feet/minute. The resulting froth foam layer in each Example had a density of 1.5 pounds per cubic foot and was ½ inch thick. The foam in Example 4, based on the prepolymer from Example 2, had some large voids and slits directly below the aluminum foil layer. The foam in Example 3, based on the prepolymer from Example 1, was free of these defects.

### Example 5 and Example 6

The prepolymers of Example 1 and 2 were separately combined with a proprietary blend comprising one or more polyols, one or more catalysts, one or more surfactants, and water in an Oakes foamer in which air was injected to prepare the frothed foams used in Examples 5 and 6, respectively. The process used for preparing the composites was as described above in Examples 3 and 4. Each of the fresh composites were then transported through an oven set at 250° F. that was 120 feet long, at a speed of 75 feet/minute. The resulting froth foam layer in each Example had a density of 1.5 pounds per cubic foot and was ½ inch thick. At this speed, the frothed foam in Example 5, based on the prepolymer from Example 1, remained defect free. The foam in Example 6, based on the prepolymer from Example 2, had defects (i.e. large voids and slits directly below the aluminum foil layer). In fact, the number of defects in Example 6 was larger than the number of defects in Example 4. Examples 4 and 6 were identical except for the speed at which they passed through the oven.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A prepolymer of toluene diisocyanate comprising:
(A) from 95 to 99.99% by weight, based on 100% by weight of the total weight of (A) and (B), of a prepolymer of toluene diisocyanate having an NCO group content of from about 2 to about 40% and which comprises the reaction product of:
(1) toluene diisocyanate having from about 60 to about 100% by weight of the 2,4-isomer and from about 0 to about 40% by weight of the 2,6-isomer, with the %'s by weight of the 2,4-isomer and the 2,6-isomer totaling 100% by weight of the toluene diisocyanate, and
(2) an isocyanate-reactive component comprising having a functionality of from about 1.5 to about 8 and an OH number of from about 14 to about 1870; and
(B) from about 0.01 to about 5.0% by weight, based on 100% of the total weight of (A) and (B) of an epoxide having an epoxide equivalent weight of from about 44 to about 400.

2. The prepolymer of claim 1, comprising:
(A) from about 97 to about 99.9% by weight of a prepolymer of toluene diisocyanate, and
(B) from about 0.1 to about 3% by weight of an epoxide.

3. The prepolymer of claim 1, wherein (A) said prepolymer of toluene diisocyanate has an NCO group content of from about 5 to about 25%.

4. The prepolymer of claim 1, wherein (A)(2) said isocyanate-reactive component comprises a polyether polyol.

5. The prepolymer of claim 1, wherein (A)(2) said isocyanate-reactive component has a functionality of from about 2 to about 4 and an OH number of from about 20 to about 600.

6. A process for preparing prepolymers of toluene diisocyanate, comprising:
(A) reacting
(1) toluene diisocyanate having from about 60 to about 100% by weight of the 2,4-isomer and from about 0 to about 40% by weight of the 2,6-isomer, with the %'s by weight of the 2,4-isomer and the 2,6-isomer totaling 100% by weight of the toluene diisocyanate, and
(2) an isocyanate-reactive component having a functionality of from about 1.5 to about 8 and an OH number of from about 14 to about 1870,
to form an isocyanate-terminated prepolymer of toluene diisocyanate; and
(B) adding
(1) from about 0.01 to about 5.0% by weight of an epoxide having an epoxide equivalent weight of from about 44 to about 400, to
(2) about 99.99 to about 95% by weight of the isocyanate-terminated prepolymer of toluene diisocyanate formed in (A),
with the %'s by weight of (B)(1) and (B)(2) totaling 100% by weight.

7-17. (canceled)
